(19) United States
(12) Patent Application Publication
(10) Pub. No.: US 2026/0295956 A1
(43) Pub. Date: Oct. 1, 2026

(54) KIT FOR REPAIRING A PUNCTURED TIRE OF A VEHICLE

(71) Applicant: SELLE ROYAL USA, INC., SAN CLEMENTE, CA (US)

(72) Inventor: Jared William LOZONNE, Laguna Beach, CA (US)

(21) Appl. No.: 19/091,184

(22) Filed: Mar. 26, 2025

(51) Int. Cl. B29C 73/08; B29L 30/00

(52) U.S. Cl. CPC B29C 73/08; B29L 2030/00

(57) ABSTRACT

The present invention relates to a tire plug anchor or fitting component for a kit for repairing a punctured tire of a vehicle, such as a bicycle.

### TECHNICAL FIELD OF THE INVENTION

The present invention relates to an anchor or fitting component for a kit for repairing a punctured tire of a vehicle, such as a bicycle, as well as to a kit and a method for repairing a tire with such a kit.

### STATE OF THE ART

A number of solutions are available for repairing a punctured tire, such as for example tire plugs.

A tire plug is a type of repair tool used to seal small punctures in a tire, typically in the tread area, caused by nails, screws, or other sharp objects. It is a short piece of rubber or synthetic material that is inserted into the hole to stop air from leaking out and restore the tire's functionality.

With such a solution, the object causing the puncture is removed, then the tire plug is threaded through a special insertion tool resembling a needle.

At this point, the plug is pushed into the puncture hole using the tool, leaving part of the plug inside the tire and a small amount protruding.

According to the known state of the art:
tire plugs are removed when trying to remove the tire plug insertion tool.
often tire plugs fall out of the tire while cycling;
tire plug anchors use a pointed shape that can damage the rim and rim tape;
tire plug anchors require relatively little force to remove.

### SUMMARY OF THE INVENTION

It is therefore a principal object of the present invention to provide a new anchor or fitting component, kit and method for repairing a punctured tire of a vehicle, such as a bicycle.

Another object of the present invention is to provide an anchor or fitting component, a kit and a method as above indicated that prevent that tire plug to be removed when trying to remove the tire plug insertion tool.

A further object of the present invention is to provide an anchor or fitting component, a kit and a method as aforementioned, which make it possible to obtain a stronger engagement of the tire plug inside a puncture hole, so that it does not easily fall out the tire.

Object of the present invention is even to provide an anchor or fitting component, a kit and a method as above indicated in which the anchor does not damage the rim and rim tape.

According to the present invention an anchor or fitting component as described in the present application is provided.

According to the present invention a kit as described in the present application is provided.

According to another aspect of the present invention a method as described in the present application is provided.

The present application refers to preferred and advantageous embodiments of the invention.

### BRIEF DESCRIPTION OF THE DRAWINGS

These and other advantages will be better understood by any man skilled in the art from the following description and from the attached drawings, given as a not-limiting example, in which:

FIGS. 1 to 4 are lateral, perspective, front and rear, respectively, views of an anchor for a kit according to the present invention,

FIG. 5 is a cross-section view taken along the line V-V of FIG. 4,

FIG. 6 shows a kit according to the present invention in an exploded view,

FIGS. 7 to 11 show respective steps of a method for repairing a tire with a kit according to the present invention, and

FIGS. 12 to 16 show, each from a respective perspective or side, an anchor and a tool plug according to the present invention inserted in a puncture hole of a punctured tire during respective steps of a method.

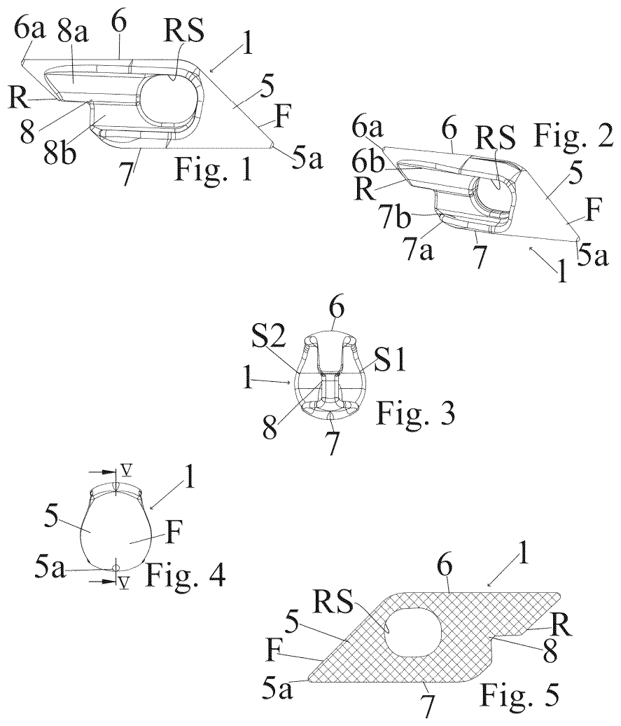

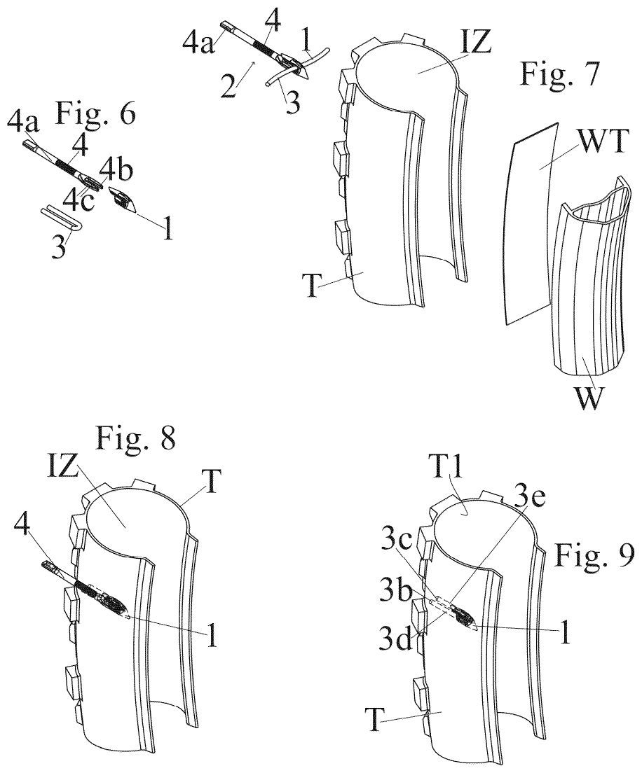

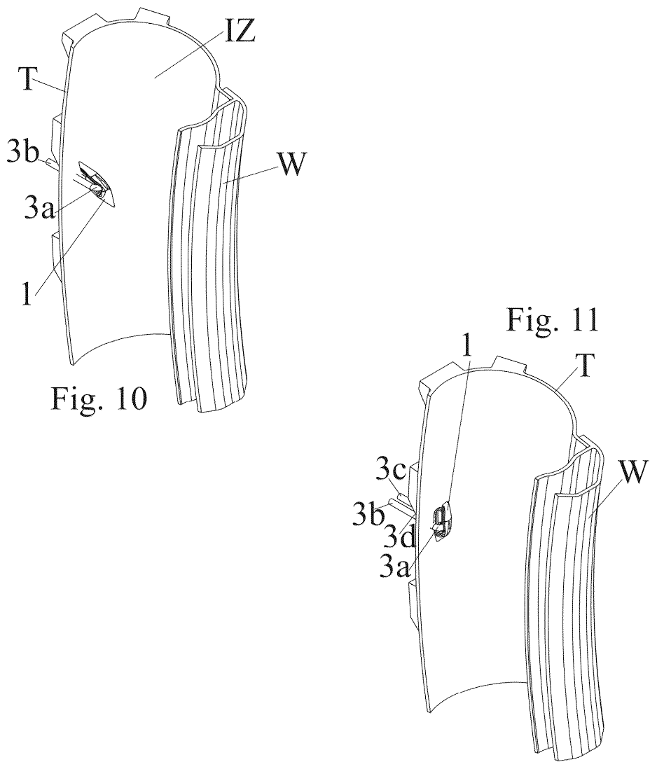

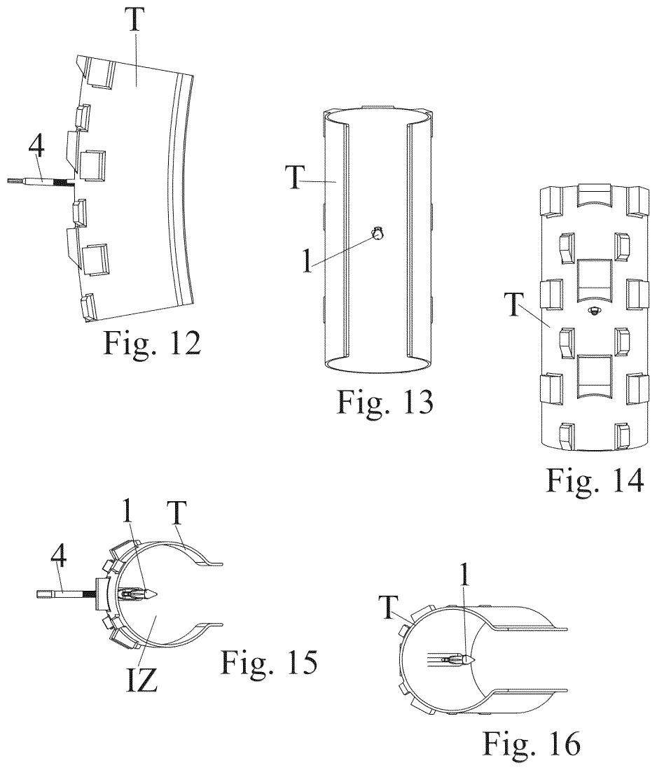

### DETAILED DESCRIPTION

The present invention relates to a tire plug anchor or fitting component 1 for a kit 2 for repairing a punctured tire T of a vehicle, such as a bicycle, as well as relates to such a kit or system comprising:
a tire plug 3,
a tire plug insertion tool 4, and
the tire plug anchor 1.

Of course, the tire T can be mounted on a wheel rim W optionally provided with a wheel rim tape WT.

More particularly, the anchor or fitting component 1 is suitable for receiving a part or a section of a tire plug 3 and then dragging it, owing to the actuation of a tire plug insertion tool 4, throughout a puncture hole of a punctured tire T.

The anchor 1 has a front F and a rear R, a top, a bottom and two sides S1, S2 and it delimits a receiving seat RS, so that the tire plug 3 or rather a section or portion 3a thereof can be inserted and kept in position therein during the insertion throughout a puncture hole of a punctured tire T and even, as will be discussed later, after the insertion step. The term front F and rear R refer to the position of insertion of the anchor or fitting component 1 in a punctured tire T, i.e. the front F is inserted first, and the rear R as last part.

Advantageously, the anchor or fitting component 1 has a tip 5 defining the front F and a main core or body defining the rear R and delimiting the receiving seat RS, the main core or body having two wall sections, namely a top wall section 6 and a bottom wall section 7 defining one the top and the other the bottom of the anchor or fitting component 1.

In this respect, the top and bottom are the zones or surfaces of the anchor or fitting component 1 defining, with the sides S1, S2 the main surfaces of the main body, and thus, as it will be understood the term top and bottom do not define a geometrical constrain for the arrangement of the anchor or fitting component while being used.

The wall sections 6, 7 extends from the tip 5 towards the rear R and are spaced with respect to each other.

Preferably, the wall sections 6, 7 are substantially parallel to each other or slightly curved, but with the direction rear R-front F lying in the plane of main extension of the wall sections 6, 7.

Advantageously, the anchor or fitting component 1 further includes a connecting section 8 bridge connecting the wall sections 6, 7, so that the receiving seat RS is defined in the connecting section 8 among the tip 5, the wall sections 6, 7 and the connecting section 8.

In this respect, the receiving seat RS is shaped as a through opening or hole and extends in a direction from one side S1 to the other S2 or it is open towards the sides S1, S2 and preferably closed at the front F and the rear R, and thus open towards the sides S1, S2 only.

As a not preferred alternative, the receiving seat RS is at least partially closed at the rear R, for example with a slit delimited in the connecting section departing from the receiving seat RS rearwards. In this case, the slit would be smaller than the tire plug 3, so as to prevent or limit the insertion of the latter in the slit.

So far as the connecting section 8 is concerned, the same has preferably a thickness or width, i.e. the size from one side S1 to the other S2, lower than the wall sections 6, 7, but, of course, this is not a mandatory option.

With reference to the not limiting embodiment shown in the figures, the connecting section 8 has a first part 8a extending from a wall section 6 having a given thickness or width, for example among 1 and 3 mm or among 1.5 and 2.5 mm, lower than the wall section 6, and then a second part 8b extending from the first part 8a up to the other wall section 7 and with a thickness or width, for example among 0.2 and 2 mm or among 1 and 1.5 mm, lower than the first part 8a and than the wall section 7.

As a not limiting example, the thickness or width of the wall sections 6, 7 can be among 1,5 and 3 or 4 time the thickness or width of parts 8a and/or 8b and/or the thickness or width of the second part 8 b can be among 50% and 75% of the thickness or width of the first part 8a.

Owing to such a structure, among first part 8a, second part 8b and one of the wall sections, preferably the shortest one 7, a recessed zone for the engagement of the tire plug insertion tool 4 is defined.

The anchor 1 could advantageously have a rear end at a distance from the receiving seat RS decreasing in the direction from one wall section 6 to the other 7.

In this respect, the wall sections can be for example one 6 longer (direction rear R-front F) than the other 7, so that the rear end 6a of one 6 of the wall sections is further away from the front F or rather from the receiving seat RS than the rear end 7a of the other wall section 7.

In this respect, the longest wall section 6 can optionally have a sharp terminal or rear end 6a.

Of course, as a not preferred alternative, the wall sections 6, 7 have the same length, i.e. the direction front the rear R to the front F.

If the wall sections 6, 7 have a different length and the connecting section 8 has two parts 8a, 8b, then the first part 8a will be advantageously longer that the second part 8b.

In this respect, the distance of rear end of the anchor 1 from the receiving seat RS starting from the longest wall section 6 towards the other 7, could decrease in the first part 8a owing to the inclined extension, and then remarkably decrease from the first part 8a to the second part 8b following a step-wise trend.

Referring now to the tip 5, it has advantageously a rounded shape or in any case not a sharp shape.

The tip 5 has preferably a substantially conical shape or in any case it is tapered, but with an axis of symmetry or of main extension which is inclined with respect to the rear R-front F direction or to the direction of main extension of the wall sections 6, 7.

More particularly, the axis of symmetry or of main extension of the tip 5 is inclined so that the terminal end 5a of the latter is closer to one wall section than the other, for example it is closer to the shortest wall section 7. In this respect, the terminal end 5a of the tip 5 is preferably substantially aligned with one of the wall sections 6, 7, for example with the shortest wall section 7 and staggered with respect to the other wall section 6.

The anchor 1 is preferably made enbloc of a suitable material, such as plastic, metal or another suitable material.

Referring now in particular to the tire plug 3, it can for example consist of a flexible (enough to conform to the shape of the puncture) string or rope, made of a suitable material, such as rubbery or fabric-based material, for example coated with a sticky adhesive.

The tire plug 3 can be long and substantially cylindrical (like a string).

So far as the tire plug insertion tool 4 is concerned, it can have any suitable shape.

Referring to the not limiting embodiment shown in the figure, the tool 4 includes a handle portion 4a, which can be for example rod-shaped, and an operating head 4b extending from the handle portion 4a.

The operating head 4b is structured and sized so as to engage, for example snap-engage or force engage or engage by shape or screw engage, the anchor or fitting component 1 preferably starting from the rear R of the latter, so that the tool 4 can control displacements of the anchor or fitting component 1 and insertion of the same in a puncture hole of a punctured tire T.

Optionally, the operating head 4b is even sized for engaging and pushing the tire plug 3 with a section or portion 3a housed into the receiving seat RS.

The head 4b can have any suitable shape, for example with a height lower than the distance among the wall sections 6, 7 or rather the inner surfaces 6b, 7b thereof or better lower than the width of the recessed zone optionally delimited among first part 8a, second part 8b and one of the wall sections 7, so that the head can be removably fitted or inserted in a zone among such wall sections or in the recessed zone.

Thus, for example, the head 4b can be fork-shaped with two tines 4c having a height, i.e. the dimension, in use or when the tool 4 is engaged with the anchor 1, from one wall section 6 towards the other 7, as above indicated and distance greater than the thickness, i.e. the dimension from one side S1 to the other S2, of the second part 8b.

Owing to such structure, the head 4b is fittable with its tines 4c each mounted in a branch or side of the recessed zone.

Of course, the head 4b could have a shape even different.

Subject-matter of the present invention is also a method for repairing a punctured tire T with a kit 2, such method comprising the following step:
housing a section or portion 3a of the tire plug 3 into the receiving seat RS,
engaging the insertion tool 4 with the anchor 1 optionally so as to engage and push the tire plug 3,
actuating the insertion tool 4 so as to determine the whole anchor or fitting component 1 to cross the puncture hole to be closed of a punctured tire T, thereby determining a partial insertion of the tire plug 3 throughout the puncture hole, optionally following the bending for example to a substantially U-shape, of the tire plug 3, in such a way that the terminal ends 3b, 3c of the tire plug 3 do not cross the puncture hole and are outside the tire T or rather the inner zone IZ of a tired wheel, i.e. the zone among tire T and wheel rim W of the latter,
removing the insertion tool 4, i.e. moving it backwards throughout the puncture hole and outside the inner zone IZ, -
pulling the terminal ends 3b, 3c of the tire plug 3 so that the rear R of the anchor or fitting component 1 abuts against an inner surface T1 of the tire T or in any case, if the abutment was or not already present, is pressed towards such inner surface T1, thereby causing a rotation or roto-translation of the anchor or fitting component 1 until a respective side or part rests against the inner surface T1 of the tire T, advantageously partly closing the puncture hole.

With reference first to the housing step, the tire plug 3, optionally in a not deformed state, is preferably inserted in the receiving seat RS with a direction of main extension of the tire plug 3 transversal or orthogonal to the direction from the rear R to the front F and substantially parallel to the direction from one side S1 to the other side S2, so that the terminal ends 3b, 3c protrude each from respective side S1, S2 of the anchor or fitting component 1.

Advantageously, during such step, the tire plug 3 is inserted into the receiving seat RS from one side S1 so that it protrudes from the other S2 for a desired length.

With reference now to the fitting step, the insertion tool 4 is preferably engaged with the anchor 1, preferably with the recessed zone, optionally with the tines 4c of the head 4b each mounted in a branch or side of the recessed zone, with a direction of main extension of the insertion tool 4 or rather of the respective handle portion 4a substantially parallel to the direction from the rear R to the front F.

As relates to the actuating step, acting on the insertion tool 4, the anchor tip 5 is fitted in the puncture hole, so that the anchor or fitting component 1 wholly pass throughout the same and reach the inner zone IZ of the tired wheel.

During such step, the tire plug 3 is bent, so that a first portion of the tire plug 3, namely a U-shaped portion 3a housed in the receiving seat RS, is dragged throughout the puncture hole into the inner zone IZ, a second portion 3d, 3e of the tire plug 3, consisting of two parallel segments of the tire plug 3, one opposite to the other with respect to the anchor 1, extends among the inner zone IZ and the zone outside the tired wheel and a third portion or portions of the tire plug 3, namely the terminal ends 3b, 3c thereof or rather of the parallel segments, are outside the tire 3.

At the end of this step, the anchor or fitting component 1 is located with the rear R or the ends of the wall sections 6, 7 facing towards the puncture hole or the inner surface T1 and the tip 5 facing away from the latter.

During the removing of the insertion tool 4, the pulling force from removing the tire plug tool 4 could also cause the anchor or fitting component 1 to catch or abut the inner surface T1 of the tire T, this advantageously keeping the anchor or fitting component 1 or rather the end of the longest wall section 6 and optionally of the first part 8a (if present), inside the tire T, even for a small amount.

In connection now with the pulling step, as already indicated the terminal ends 3b, 3c of the tire plug 3 are outside the inner zone IZ, and thus the same can be pulled, thereby determining, mainly acting on the anchor or fitting component 1 at the receiving seat RS, a displacement of the anchor or fitting component 1 towards the puncture hole and the abutment of the rear R of the anchor or fitting component 1 against an inner surface T1 of the tire T, or in any case, if the abutment was obtained during the removing step, determining a displacement of the anchor or fitting component 1 so that it is pressed towards the inner surface T1, which causes a rotation or roto-translation of the anchor or fitting component 1 until a respective side or outer surface rests against the inner surface T1 of the tire T.

More particularly, with reference to the not limiting embodiment shown in the figures, the end of one wall section, for example the longest wall section 6 abuts or presses against the inner surface T1 of the tire T or in any case against the tire T and thus a rotation or roto-translation is determined bringing one of the wall sections 6, 7 (for example of the shortest wall section 7) or rather the outer surface thereof into abutment with the inner surface T1 of the tire T, of course at the puncture hole, so that the latter is actually partially closed by the anchor or fitting component 1, i.e. the latter limits the access to the puncture hole for the tire plug 3.

Thus, at this point, the anchor or fitting component 1 extends with rear R-front F direction substantially orthogonal or transversal to the puncture hole, i.e. the direction from the outer end to the inner end (with reference to the inner zone) of the puncture hole.

The tire plug 3 has instead a first U-shaped portion astride of one wall section, for example the shortest one 7, from which U-shaped portion two substantially parallel segments of the tire plug 3 extends among the inner zone IZ or rather each among a respective side S1, S2 of the anchor or fitting component 1 and the zone outside the tired wheel up to the terminal ends 3b, 3c.

As a matter of fact, by pulling on the tire plug ends 3b, 3c, the anchor or fitting component 1 rotates or roto-translates inside the inner zone IZ, increasing its surface area in relation to the puncture hole size, this preventing the tire plug 3 and anchor or fitting component 1 from coming out from the inner zone IZ.

As it will be understood, owing to the present invention, tire plug anchor 1 prevents tire plugs 3 from coming back out during installation and during bicycling activity.

Moreover, the position of the anchor or fitting component 1 at the end of the method, prevents the tire plug anchor or fitting component 1 from pointing towards the wheel rim W, thereby protecting the wheel rim W and rim tape WT from damage.

Furthermore, tire plug anchor or fitting component 1 according to the present invention is compatible with existing tire plugs and tire plug insertion tools, making this a unique product with additional utility for the bicycle market preventing the tire plug 3 from being removed from the tire outwardly.

This is important for the invention because other tire plug anchor designs require special tools to insert the anchor into the tire, such as allen wrenches and other tools.

1. A tire plug anchor or fitting component for a kit for repairing a punctured tire of a vehicle, such as a bicycle, the tire plug anchor or fitting component being suitable for receiving a part or a section of a tire plug and then dragging the tire plug, owing to the actuation of a tire plug insertion tool throughout a puncture hole of a punctured tire, the anchor or fitting component having a front and a rear, a top, a bottom and two sides and delimiting a receiving seat, so that a section or portion of a tire plug can be inserted and kept in position therein during the insertion throughout a puncture hole of a punctured tire.

2. The tire plug anchor or fitting component as claimed in claim 1, comprising a tip defining the front and a main core or body defining the rear and delimiting the receiving seat, the main core or body having two wall sections, namely a top wall section and a bottom wall section defining one the top and the other the bottom of the anchor or fitting component.

3. The tire plug anchor or fitting component as claimed in claim 2, wherein the wall sections are substantially parallel to each other or slightly curved, the direction rear-front lying in the plane of main extension of the wall sections.

4. The tire plug anchor or fitting component as claimed in claim 2, comprising a connecting section bridge connecting the wall sections, so that the receiving seat is defined in the connecting section or among the tip, the wall sections and the connecting section, and thus the receiving seat is shaped as a through opening or hole and extends in a direction from one side to the other.

5. The tire plug anchor or fitting component as claimed in claim 4, wherein the connecting section has a first part extending from a wall section having a given thickness or width lower than the latter, and then a second part extending from the first part up to the other wall section and with a thickness or width lower that the first part.

6. The tire plug anchor or fitting component as claimed in claim 2, wherein the anchor has a rear end at a distance from the receiving seat decreasing in the direction from one wall section to the other.

7. The tire plug anchor or fitting component as claimed in claim 2, wherein the wall sections are one longer than the other, so that the rear end of one of the wall sections is further away from the front or rather from the receiving seat than the rear end of the other wall section.

8. The tire plug anchor or fitting component as claimed in claim 7, wherein the distance of rear end of the anchor or fitting component from the receiving seat starting from one longest wall section towards the other, first decrease owing to the inclined extension, and then decrease following a step-wise trend.

9. The tire plug anchor or fitting component as claimed in claim 2, wherein the tip has a rounded shape or in any case not a sharp shape.

10. The tire plug anchor or fitting component as claimed in claim 2, wherein the tip has a substantially conical shape or in any case it is tapered, but with an axis of symmetry or of main extension which is inclined with respect to the rear-front direction or to the direction of main extension of the wall sections.

11. The tire plug anchor or fitting component as claimed in claim 10, wherein the axis of symmetry or of main extension of the tip is inclined so that the terminal end of the latter is closer to one wall section than to the other.

12. The tire plug anchor or fitting component as claimed in claim 11, wherein the end of the tip is substantially aligned with one of the wall sections.

13. A kit for repairing a punctured tire of a vehicle, such as a bicycle, comprising:
a tire plug,
a tire plug insertion tool, and
the tire plug anchor or fitting component as claimed in claim 1,
the anchor or fitting component being suitable for receiving a part or section of the tire plug and then dragging the tire plug, owing to the actuation of the tire plug insertion tool, throughout a puncture hole of a punctured tire.

14. The kit as claimed in claim 13, wherein the tire plug insertion tool includes a handle portion and an operating head extending from the handle portion, the operating head being structured and sized so as to engage the anchor or fitting component, so that the tool can control displacement of the anchor or fitting component and insertion of the same in a puncture hole of a punctured tire.

15. The kit as claimed in claim 14, wherein the anchor or fitting component comprises a tip defining the front and a pair of wall sections extending from the tip towards the rear, the sections being spaced with respect to each other, and wherein the head has a height lower than the distance among the wall sections, so that the head can be removably fitted or inserted in a zone among such wall sections.

16. The kit as claimed in claim 15, wherein the anchor or fitting component comprises a connecting section bridge connecting the wall sections, so that the receiving seat is defined in the connecting section or among the tip, the wall sections and the connecting section, and thus the receiving seat is shaped as a through opening or hole and extends in a direction from one side to the other.

17. The kit as claimed in claim 16, wherein the connecting section has a first part extending from a wall section having a given thickness or width lower than the latter, and then a second part extending from the first part up to the other wall section and with a thickness or width lower that the first part, and
wherein the head has a height lower than the width of the recessed zone delimited among first part, second part and one of the wall sections, so that the head can be removably fitted or inserted in said recessed zone.

18. The kit as claimed in claim 17, wherein the head is fork-shaped with two tines having a height lower than the width of the recessed zone.

19. A method for repairing a punctured tire with the kit as claimed in claim 13, comprising the following steps:
housing a section or part of the tire plug into the receiving seat,
engaging the insertion tool with the anchor or fitting component, optionally so as to engage and push the tire plug,
actuating the insertion tool so as to determine the whole anchor or fitting component to cross the puncture hole to be closed of a punctured tire, thereby determining a partial insertion of the tire plug throughout the puncture hole, in such a way that the terminal ends of the tire plug do not cross the puncture hole and are outside the inner zone of a tired wheel, i.e. the zone among tire and wheel rim,
removing the insertion tool, i.e. moving it backwards throughout the puncture hole and outside the inner zone,
pulling the terminal ends of the tire plug so that the rear of the anchor or fitting component abuts against an inner surface of the tire or in any case, if the abutment was or not already present, so that the rear of the anchor or fitting component is pressed towards such inner surface, thereby causing a rotation or roto-translation of the anchor or fitting component until a respective side or part rests against the inner surface of the tire.

20. The method as claimed in claim 19, wherein during the housing step, the tire plug is inserted in the receiving seat with a direction of main extension of the tire plug transversal or orthogonal to the direction from the rear to the front and substantially parallel to the direction from one side to the other side of the anchor or fitting component, so that the terminal ends protrude each from respective side of the anchor or fitting component.

21. The method as claimed in claim 19, wherein during the actuating step, acting on the insertion tool, the anchor or fitting component tip is fitted in the puncture hole, so that the anchor or fitting component wholly pass throughout the same and reach the inner zone of the tired wheel.

22. The method as claimed in claim 19, wherein during the actuating step, the tire plug is bent, so that a first portion of the tire plug, namely a U-shaped portion housed in the receiving seat, is dragged throughout the puncture hole into the inner zone, a second portion of the tire plug, consisting of two parallel segments of the tire plug, extends among the inner zone and the zone outside the tired wheel and a third portion or portions of the tire plug, namely the terminal ends thereof or rather of the parallel segments, are outside the tire.

23. The method as claimed in claim 19, wherein during the pulling step, the end of one top or bottom wall section of the anchor or fitting component abuts or presses against the tire and thus a rotation or roto-translation is determined bringing one of the wall sections or rather the outer surface thereof into abutment with the inner surface of the tire at the puncture hole, so that the latter is actually partially closed by the anchor or fitting component, and at this point, the anchor or fitting component extends with rear-front direction substantially orthogonal or transversal to the puncture hole.
